(19) United States
(12) Patent Application Publication
(10) Pub. No.: US 2008/0107183 A1
(43) Pub. Date: May 8, 2008

(54) METHOD AND APPARATUS FOR DETECTING ZERO COEFFICIENTS

(75) Inventor: Chanchal Chatterjee, Encinitas, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/697,358

(22) Filed: Apr. 6, 2007

Related U.S. Application Data
(60) Provisional application No. 60/863,984, filed on Nov. 2, 2006.

(51) Int. Cl. H04B 1/66

(52) U.S. Cl. 375/240.24; 375/E07.258

(57) ABSTRACT

A method and apparatus for determining whether a block of pixels will likely contain all zero coefficients for various video encoding functions are disclosed. For example, the method receives or obtains a block of pixels from an input image and computes a distortion measure for the block of pixels. The method then determines whether the block of pixels contains all zero coefficients in accordance with the distortion measure.

This application claims the benefit of U.S. Provisional Application No. 60/863,984 filed on Nov. 2, 2006, which is herein incorporated by reference.

### BACKGROUND OF THE INVENTION

1. Field of the Invention

The present invention relates to video encoders and, more particularly, to a method and apparatus for detecting zero coefficients for various video encoding functions.

2. Description of the Background Art

The International Telecommunication Union (ITU) H.264 video coding standard is able to compress video much more efficiently than earlier video coding standards, such as ITU H.263, MPEG-2 (Moving Picture Experts Group), and MPEG-4. H.264 is also known as MPEG-4 Part 10 and Advanced Video Coding (AVC). H.264 exhibits a combination of new techniques and increased degrees of freedom in using existing techniques. Among the new techniques defined in H.264 are 4×4 and 8×8 discrete cosine transform (DCT). Since transformed quantized coefficients are used to form the final outputs of the encoding process, and since various encoding functions (e.g., motion estimation, intra prediction, and mode selection) involve numerous coefficient calculations, it is helpful to be able to quickly determine if a block will result in all zero coefficients by using simple computations.

For example, a method for implementing 4×4 intra mode decision is to compute coefficients for each 4×4 predicted region subtracted from the original or reconstructed pixels for all nine modes. Since a macroblock has 16 4×4 blocks, the method may have to perform 16×9=144 transforms and quantizations steps. Once all the computations are completed, the method will then be able to select the best mode. Unfortunately, this large number of calculations is computationally expensive and may be prohibitively large for real-time systems. Accordingly, there exists a need in the art for detecting zero coefficients for various video encoding functions in a more efficient manner.

### SUMMARY OF THE INVENTION

In one embodiment, the present invention discloses a method and apparatus for determining whether a block of pixels will likely contain all zero coefficients for various video encoding functions. For example, the method receives or obtains a block of pixels from an input image and computes a distortion measure for the block of pixels. The method then determines whether the block of pixels contains all zero coefficients in accordance with the distortion measure.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a video encoder;

FIG. 2 a flow diagram depicting an exemplary embodiment of a method for determining whether a block of pixels contains all non-zero coefficients in accordance with one or more aspects of the invention; and

FIG. 3 is a block diagram depicting an exemplary embodiment of a video encoder in accordance with one or more aspects of the invention.

To facilitate understanding, identical reference numerals have been used, where possible, to designate identical elements that are common to the figures.

### DETAILED DESCRIPTION OF THE INVENTION

Method and apparatus for implementing a video encoder is described. More specifically, the present invention discloses an implementation of an encoder, e.g., an H.264 encoder, that is capable of detecting zero coefficients (e.g., coefficients that will likely have values that will be zeros) for various video encoding functions in a more efficient manner. A brief description of the various encoding functions performed by an H.264 encoder or an H.264-like encoder is first described. One or more of these encoding functions (e.g., motion estimation, intra prediction, and mode selection) may benefit from a method that is capable of quickly detecting zero coefficients in a block.

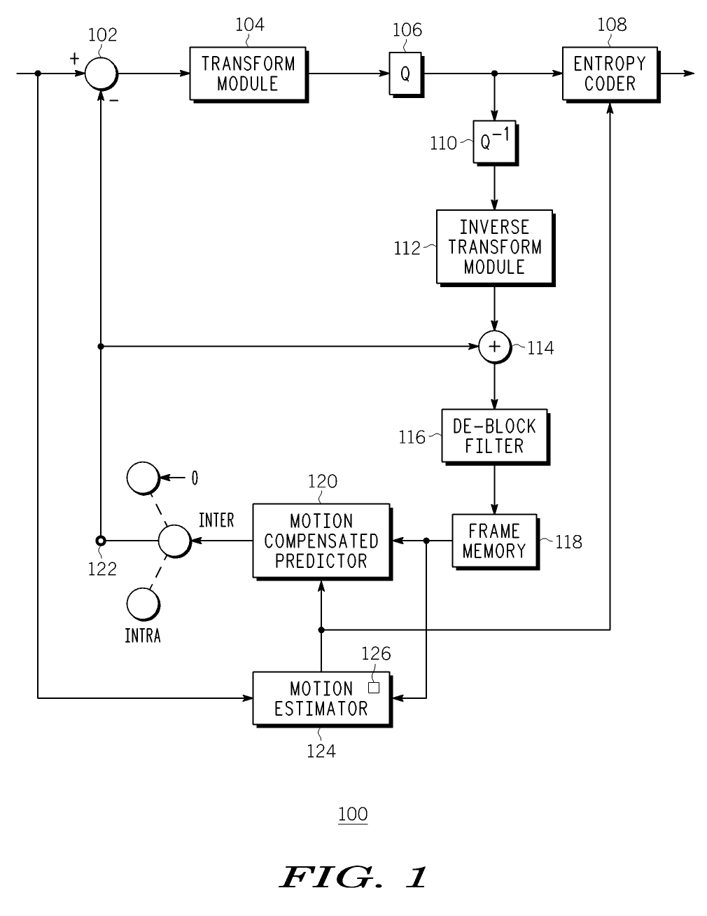

FIG. 1 is a block diagram depicting an exemplary embodiment of a video encoder 100. Since FIG. 1 is intended to only provide an illustrative example of a H.264 encoder, FIG. 1 should not be interpreted as limiting the present invention. In one embodiment, the video encoder is compliant with the H.264 standard. The video encoder 100 may include a subtractor 102, a transform module, e.g., a discrete cosine transform (DCT) like module 104, a quantizer 106, an entropy coder 108, an inverse quantizer 110, an inverse transform module, e.g., an inverse DCT like module 112, a summer 114, a deblocking filter 116, a frame memory 118, a motion compensated predictor 120, an intra/inter switch 122, and a motion estimator 124. It should be noted that although the modules of the encoder 100 are illustrated as separate modules, the present invention is not so limited. In other words, various functions (e.g., transformation and quantization) performed by these modules can be combined into a single module. In operation, the video encoder 100 receives an input sequence of source frames. The subtractor 102 receives a source frame from the input sequence and a predicted frame from the intra/inter switch 122. The subtractor 102 computes a difference between the source frame and the predicted frame, which is provided to the DCT module 104. In INTER mode, the predicted frame is generated by the motion compensated predictor 120. In INTRA mode, the predicted frame is zero and thus the output of the subtractor 102 is the source frame.

The DCT module 104 transforms the difference signal from the pixel domain to the frequency domain using a DCT algorithm to produce a set of coefficients. The quantizer 106 quantizes the DCT coefficients. The entropy coder 108 codes the quantized DCT coefficients to produce a coded frame.

The inverse quantizer 110 performs the inverse operation of the quantizer 106 to recover the DCT coefficients. The inverse DCT module 112 performs the inverse operation of the DCT module 104 to produce an estimated difference signal. The estimated difference signal is added to the predicted frame by the summer 114 to produce an estimated frame, which is coupled to the deblocking filter 116. The deblocking filter deblocks the estimated frame and stores the estimated frame or reference frame in the frame memory 118. The motion compensated predictor 120 and the motion estimator 124 are coupled to the frame memory 118 and are configured to obtain one or more previously estimated frames (previously coded frames).

The motion estimator 124 also receives the source frame. The motion estimator 124 performs a motion estimation algorithm using the source frame and a previous estimated frame (i.e., reference frame) to produce motion estimation data. For example, the motion estimation data includes motion vectors and minimum SADs (sum of absolute differences) for the macroblocks of the source frame. The motion estimation data is provided to the entropy coder 108 and the motion compensated predictor 120. The entropy coder 108 codes the motion estimation data to produce coded motion data. The motion compensated predictor 120 performs a motion compensation algorithm using a previous estimated frame and the motion estimation data to produce the predicted frame, which is coupled to the intra/inter switch 122. Motion estimation and motion compensation algorithms are well known in the art.

To illustrate, the motion estimator 124 may include mode decision logic 126. The mode decision logic 126 can be configured to select a mode for each macroblock in a predictive (INTER) frame. The “mode” of a macroblock is the partitioning scheme. That is, the mode decision logic 126 selects MODE for each macroblock in a predictive frame, which is defined by values for MB_TYPE and SUB_MB_TYPE.

The above description only provides a brief view of the various complex algorithms that must be executed to provide the encoded bitstreams generated by an H.264 encoder. The increase in complexity is often a result of a desire to provide better encoding characteristics, e.g., less distortion in the encoded images while using less number of bits to transmit the encoded images. In order to achieve these improved encoding characteristics, it is often necessary to increase the overall computational overhead of an encoder. Unfortunately, the increase in computational overhead also increases the difficulty in implementing a real-time H.264 encoder. As such, the present invention provides a method that is capable of improving various encoding functions (e.g., motion estimation, intra prediction, and mode selection) by quickly detecting zero coefficients in a block.

More specifically, in H.264/AVC video coding standard, coefficients are computed by transforming and quantizing a set of pixels known as the “residuals”. For example, the residual pixels may be obtained by subtracting two sets of 4×4 pixel regions that depend on the implementation as well as the section of the encoding process. For example, during intra mode selection, the residuals are obtained by subtracting the predicted pixels from the original or reconstructed pixels; while during motion estimation, the residuals are the difference of the reconstructed pixels from the original.

Let R=[rᵢⱼ], for 1≦i, j≦4, be the 4×4 residual pixel block. The transform of R is obtained as:

$$T = {ARA}^{T} , where \\ A = [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ] . \qquad ( Eq . 1 )$$

The quantization of the transformed residuals T=[tᵢⱼ], for 1≦i, j≦4, is obtained as:

$${c}_{ij} = Sgn ( {t}_{ij} ) \frac{\vert {t}_{ij} \vert {M}_{b} + f}{h} , for 1 \leq i , j \leq 4 , \qquad ( Eq . 2 )$$

where
Sgn(x)=+1 for x≧0, and −1 otherwise,
M_{b} is a level scale constant defined below (in Eq. 3),
h=2^{└Q/6┘+15},
f=h/3 for Intra and h/6 for Inter prediction.

Here └.┘ is the floor operator, and Q is the quantization parameter or level. The level scale constant M_{b} is an element m_{ab} of the matrix M below where the row a=1+(Q %6), and column b=1+(i %2)+(j %2) of M, and % is the modulo operator. Matrix M is:

$$Q \%6 {M}_{1} {M}_{2} {M}_{3} \\ \begin{matrix}M = \begin{matrix}0 \\ 1 \\ 2 \\ 3 \\ 4 \\ 5\end{matrix} & [ \begin{matrix}5243 & 8066 & 13107 \\ 4660 & 7490 & 11916 \\ 4194 & 6554 & 10082 \\ 3647 & 5825 & 9362 \\ 3355 & 5243 & 8192 \\ 2893 & 4559 & 7282\end{matrix} ]\end{matrix} . \qquad ( Eq . 3 )$$

Let M₁ be an element of matrix M from a given row (determined by Q %6) from column 1 of M, and M₂ be an element from the same row and column 2, and M₃ be an element from the same row and column 3 of M. Then we have from M above:

M₁<M₂<M₃. (Eq. 4)

It should be noted that the matrix transform T=ARA^{T} can be simplified into 16 vector inner products as follows:

$$T = [ \begin{matrix}{w}_{11}^{T} r & {w}_{12}^{T} r & {w}_{13}^{T} r & {w}_{14}^{T} r \\ {w}_{21}^{T} r & {w}_{12}^{T} r & {w}_{23}^{T} r & {w}_{24}^{T} r \\ {w}_{31}^{T} r & {w}_{32}^{T} r & {w}_{33}^{T} r & {w}_{34}^{T} r \\ {w}_{41}^{T} r & {w}_{42}^{T} r & {w}_{43}^{T} r & {w}_{44}^{T} r\end{matrix} ] , \\ where \\ {r}^{T} = [ {r}_{11} {r}_{12} {r}_{13} {r}_{14} {r}_{21} {r}_{22} {r}_{23} {r}_{24} {r}_{31} {r}_{32} {r}_{33} {r}_{34} {r}_{41} {r}_{42} {r}_{43} {r}_{44} ] , \\ {w}_{11}^{T} = [ 1 \; 1 \; 1 \; 1 \; 1 \; 1 \; 1 \; 1 \; 1 \; 1 \; 1 \; 1 \; 1 \; 1 \; 1 \; 1 ] , \\ {w}_{12}^{T} = [ 2 \; 1 - 1 - 2 \; 2 \; 1 - 1 - 2 \; 2 \; 1 - 1 - 2 \; 2 \; 1 - 1 - 2 ] , \\ {w}_{13}^{T} = [ 1 - 1 - 1 \; 1 \; 1 - 1 - 1 \; 1 \; 1 - 1 - 1 \; 1 \; 1 - 1 - 1 \; 1 ] , \\ {w}_{14}^{T} = [ 1 - 2 \; 2 - 1 \; 1 - 2 \; 2 - 1 \; 1 - 2 \; 2 - 1 \; 1 - 2 \; 2 - 1 ] , \\ {w}_{21}^{T} = [ 2 \; 2 \; 2 \; 2 \; 1 \; 1 \; 1 \; 1 - 1 - 1 - 1 - 1 - 2 - 2 - 2 - 2 ] , \\ {w}_{22}^{T} = [ 4 \; 2 - 2 - 4 \; 2 \; 1 - 1 - 2 - 2 - 1 \; 1 \; 2 - 4 - 2 \; 2 \; 4 ] , \\ {w}_{23}^{T} = [ 2 - 2 - 2 \; 2 \; 1 - 1 - 1 \; 1 - 1 \; 1 \; 1 - 1 - 2 \; 2 \; 2 - 2 ] , \\ {w}_{24}^{T} = [ 2 - 4 \; 4 - 2 \; 1 - 2 \; 2 - 1 - 1 \; 2 - 2 \; 1 - 2 \; 4 - 4 \; 2 ] , \\ {w}_{31}^{T} = [ 1 \; 1 \; 1 \; 1 - 1 - 1 - 1 - 1 - 1 - 1 - 1 - 1 \; 1 \; 1 \; 1 \; 1 ] , \\ {w}_{32}^{T} = [ 2 \; 1 - 1 - 2 - 2 - 1 \; 1 \; 2 - 2 - 1 \; 1 \; 2 \; 2 \; 1 - 1 - 2 ] , \\ {w}_{33}^{T} = [ 1 - 1 - 1 \; 1 - 1 \; 1 \; 1 - 1 - 1 \; 1 \; 1 - 1 \; 1 - 1 - 1 \; 1 ] , \\ {w}_{34}^{T} = [ 1 - 2 \; 2 - 1 - 1 \; 2 - 2 \; 1 - 1 \; 2 - 2 \; 1 \; 1 - 2 \; 2 - 1 ] , \\ {w}_{41}^{T} = [ 1 \; 1 \; 1 \; 1 - 2 - 2 - 2 - 2 \; 2 \; 2 \; 2 \; 2 - 1 - 1 - 1 - 1 ] , \\ {w}_{42}^{T} = [ 2 \; 1 - 1 - 2 - 4 - 2 \; 2 \; 4 \; 4 \; 2 - 2 - 4 - 2 - 1 \; 1 \; 2 ] , \\ {w}_{43}^{T} = [ 1 - 1 - 1 \; 1 - 2 \; 2 \; 2 - 2 \; 2 - 2 - 2 \; 2 - 1 \; 1 \; 1 - 1 ] , \\ {w}_{44}^{T} = [ 1 - 2 \; 2 - 1 - 2 \; 4 - 4 \; 2 \; 2 - 4 \; 4 - 2 - 1 \; 2 - 2 \; 1 ] . \qquad ( Eq . 6 )$$

Note that if a matrix W=[w₁₁ w₁₂ . . . w₄₃ w₄₄] is constructed, then W is orthogonal. From (Eq. 2), after combining the transform tᵢⱼ with M_{b}, we have the following 4×4 matrix for |cᵢⱼ|

$$C = ( [ \begin{matrix}{M}_{3} \vert {w}_{11}^{T} r \vert & {M}_{2} \vert {w}_{12}^{T} r \vert & {M}_{3} \vert {w}_{13}^{T} r \vert & {M}_{2} \vert {w}_{14}^{T} r \vert \\ {M}_{2} \vert {w}_{21}^{T} r \vert & {M}_{1} \vert {w}_{12}^{T} r \vert & {M}_{2} \vert {w}_{23}^{T} r \vert & {M}_{1} \vert {w}_{24}^{T} r \vert \\ {M}_{3} \vert {w}_{31}^{T} r \vert & {M}_{2} \vert {w}_{32}^{T} r \vert & {M}_{3} \vert {w}_{33}^{T} r \vert & {M}_{2} \vert {w}_{34}^{T} r \vert \\ {M}_{2} \vert {w}_{41}^{T} r \vert & {M}_{1} \vert {w}_{42}^{T} r \vert & {M}_{2} \vert {w}_{43}^{T} r \vert & {M}_{1} \vert {w}_{44}^{T} r \vert\end{matrix} ] + f * ONE ) / s , \qquad ( Eq . 5 )$$

where C=[|cᵢⱼ|] is the coefficient matrix and ONE is a 4×4 matrix of all 1s.

In order to obtain the upper bounds of |cᵢⱼ|, the present invention explores the upper bounds of M_{b}|wᵢⱼ^{T}r|, for 1≦i, j≦4, and b=1+(i %2)+(j %2). The well-known Hölder's inequality of vector norms can be used to obtain:

|wᵢⱼ^{t}r|≦wᵢⱼ∥ₚ∥r∥_{q}, (Eq. 7)

where 1≦p,q≦∞, 1/p+1/q=1, and ∥.∥ is the Lₚ norm. In one embodiment, the present invention selects values for p and q to derive an upper bound of |wᵢⱼ^{T}r|:

p=2, and q=2:

|wᵢⱼ^{T}r|≦∥wᵢⱼ∥₂∥r∥₂=∥wᵢⱼ∥₂√D, where D=∥r∥₂²=Distortion. (Eq. 8)

### Here Distortion is defined as the sum of squares of the residuals r.

From (Eq. 8), we have:

$$\vert {c}_{ij} \vert \leq \frac{{M}_{b} {‖ {w}_{ij} ‖}_{2} \sqrt{D} + f}{h} , \qquad ( Eq . 9 )$$

where b=1+(i %2)+(j %2). From (Eq. 5) and (Eq. 6), one may get three variations of M_{b}∥wᵢⱼ∥₂, which are 10M₁, \sqrt{40}M₂, and 4M₃. For different values of Q %6, these are:

$$Q \%6 \; 10 {M}_{1} \sqrt{40} {M}_{2} 4 {M}_{3} \\ \begin{matrix}\begin{matrix}0 \\ 1 \\ 2 \\ 3 \\ 4 \\ 5\end{matrix} & [ \begin{matrix}52430 & 51014 & 52428 \\ 46600 & 47371 & 47664 \\ 41940 & 41452 & 40328 \\ 36470 & 36841 & 37448 \\ 33550 & 33160 & 32768 \\ 28930 & 28834 & 29128\end{matrix} ]\end{matrix} . \qquad ( Eq . 10 )$$

For Q %6={0,2,4} 10M₁ is largest, whereas for Q %6={1,3,5} 4M₃ is largest. Thus, the new bound B1 is:

$$\vert {c}_{ij} \vert \leq \frac{10 {M}_{1} \sqrt{D} + f}{h} = {B}_{1} for Q \%6 = \{ 0 , 2 , 4 \} , \\ and \\ \vert {c}_{ij} \vert \leq \frac{4 {M}_{3} \sqrt{D} + f}{h} = {B}_{1} for Q \%6 = \{ 1 , 3 , 5 \} , \qquad ( Eq . 11 )$$

for 1≦i, j≦4. As such, the present method can detect an all zero coefficient block as:

$$D < {( \frac{h - f}{4 {M}_{3}} )}^{2} for Q \% 6 = \{ 0 , 2 , 4 \} , and \\ D < {( \frac{h - f}{10 {M}_{1}} )}^{2} or Q \% 6 = \{ 1 , 3 , 5 \} . \qquad ( Eq . 12 )$$

In one embodiment, the above B₁ bound can be slightly modified or simplified. For example, the bound B₁ in (Eq. 11) can be modified as:

$$\vert {c}_{ij} \vert \leq \frac{4 {M}_{3} \sqrt{D} + f}{h} = PB for 1 \leq Q \leq 51 , \\ and 1 \leq i , j \leq 4. \qquad ( Eq . 13 )$$

In one embodiment, the PB of Eq. 13 serves as an upper bound of |cᵢⱼ| for the detection of all zero coefficient blocks. In other words, the present method can detect an all zero coefficient block with PB as:

$$D < {( \frac{h - f}{4 {M}_{3}} )}^{2} . \qquad ( Eq . 14 )$$

In sum, the present invention has disclosed a method for quickly determining whether a block of pixels will likely contain all zero coefficients. More specifically, by computing a distortion measure D (e.g., using Eq. 8 above) for a block of pixels (e.g., a 4×4 block, or a 8×8 block and the like), one can then easily compare the computed distortion measure D against a threshold (e.g., as defined in Eq. 14) to determine whether the block of pixels will likely contain all zero coefficients. If the computed distortion measure D is less than the defined threshold,

$${( \frac{h - f}{4 {M}_{3}} )}^{2} ,$$

e.g., the right side of Eq. 14, then the block will likely contain all zero coefficients. However, If the computed distortion measure D is greater than or equal to the defined threshold, then the block will likely contain some non-zero coefficients. Therefore, the present invention provides a rapid method to determine whether a block of pixels will likely contain all zero coefficients without having to perform a transform step or a quantization step for the block of pixels. This increased efficiency allows the present invention to be implemented in real-time encoding applications.

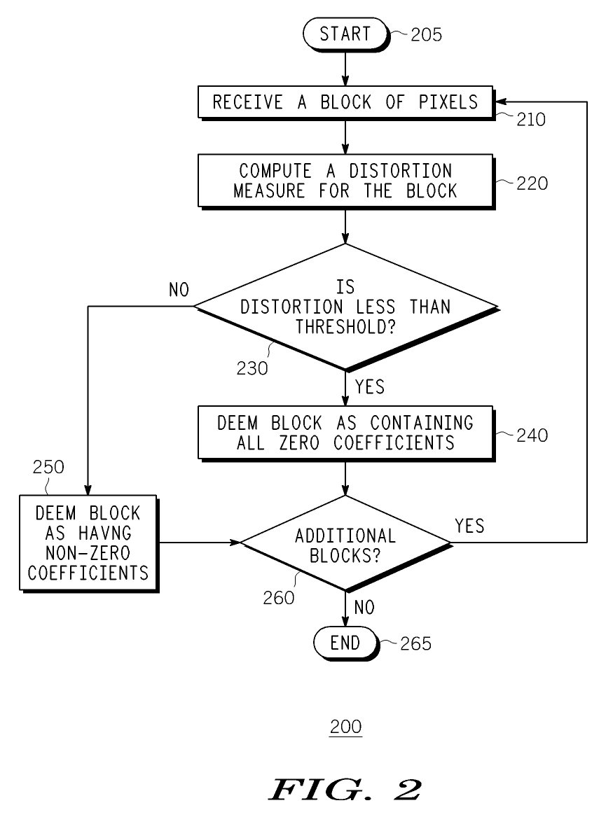

FIG. 2 a flow diagram depicting an exemplary embodiment of a method 200 for determining whether a block of pixels contains all zero coefficients in accordance with one or more aspects of the invention. Method 200 starts in step 205 and proceeds to step 210.

In step 210, method 200 receives or obtains a block of pixels for processing. For example, a block of 4×4 pixels can be selected for processing. It should be noted that although the present invention is described within the context of a 4×4 block of pixels, the present invention can be adapted to any block size, e.g., an 8×8 block of pixels and so on. It should be noted that the block of pixels can be selected to undergo various encoding functions (e.g., motion estimation, intra prediction, and mode selection).

In step 220, method 200 computes a distortion measure, e.g., D, for the block of pixels, e.g., using Eq. 8 as discussed above. For example, in the context of motion estimation, a residue r can be computed by subtracting a predicted block from a reconstructed block (or a reference block in a reference frame). In turn, the computed residue r can be used to compute the distortion measure D for the block of pixels, e.g., using Eq. 8 above, which essentially involves a sum of square operation.

In step 230, method 200 determines whether the computed distortion measure D is greater than a predefined threshold, e.g., as defined in Eq. 14. In one embodiment, a set of thresholds is provided that correlates to the number of available quantization levels or scales. For example, if there are 52 quantization levels, then a table having 52 thresholds is generated in accordance with Eq. 14 and stored. If the query is answered positively in step 230, method 200 proceeds to step 240. If the query is answered negatively, method 200 proceeds to step 250.

In step 240, method 200 will deem the block of pixels as containing all zero coefficients. In other words, an encoding function can quickly determine that this block of pixels will likely produce a block of all zero coefficients. As such, the computationally expensive steps of performing a transform operation followed by a quantization operation can be avoided for this block of pixels.

In step 250, method 200 will deem the block of pixels as containing at least one non-zero coefficient. As such, the computationally expensive steps of performing a transform operation followed by a quantization operation cannot be avoided for this block of pixels.

In step 260, method 200 determines whether there is an additional block that requires processing. If the query is answered positively, method 200 proceeds back to step 210 to receive the next block of pixels. If the query is answered negatively, method 200 ends in step 265.

It should be noted that additional encoding steps can be implemented after method 200 is performed. In other words, knowing whether a block of pixels will contain all zero coefficients will expedite the various encoding functions as described with respect to FIG. 1 for the purpose of encoding an input image.

It should be noted that although not specifically specified, one or more steps of method 200 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 2 that recite a determining operation or involve a decision, do not necessarily require that both branches of the determining operation be practiced. In other words, one of the branches of the determining operation can be deemed as an optional step.

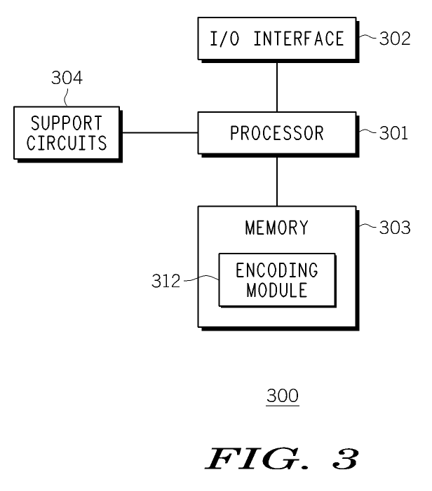

FIG. 3 is a block diagram depicting an exemplary embodiment of a video encoder 300 in accordance with one or more aspects of the invention. In one embodiment, the video encoder 300 includes a processor 301, a memory 303, various support circuits 304, and an I/O interface 302. The processor 301 may be any type of processing element known in the art, such as a microcontroller, digital signal processor (DSP), instruction-set processor, dedicated processing logic, or the like. The support circuits 304 for the processor 301 may include conventional clock circuits, data registers, I/O interfaces, and the like. The I/O interface 302 may be directly coupled to the memory 303 or coupled through the processor 301. The I/O interface 302 may be coupled to a frame buffer and a motion compensator, as well as to receive input frames. The memory 303 may include one or more of the following random access memory, read only memory, magneto-resistive read/write memory, optical read/write memory, cache memory, magnetic read/write memory, and the like, as well as signal-bearing media as described below.

In one embodiment, the memory 303 stores processor-executable instructions and/or data that may be executed by and/or used by the processor 301 as described further below. These processor-executable instructions may comprise hardware, firmware, software, and the like, or some combination thereof. Modules having processor-executable instructions that are stored in the memory 303 may include encoding module 312. For example, the encoding module 312 is configured to perform the method 200 of FIG. 2. Although one or more aspects of the invention are disclosed as being implemented as a processor executing a software program, those skilled in the art will appreciate that the invention may be implemented in hardware, software, or a combination of hardware and software. Such implementations may include a number of processors independently executing various programs and dedicated hardware, such as ASICs.

An aspect of the invention is implemented as a program product for execution by a processor. Program(s) of the program product defines functions of embodiments and can be contained on a variety of signal-bearing media (computer readable media), which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

What is claimed is:

1. A method for processing an input image, comprising:
receiving a block of pixels from said input image;
computing a distortion measure for said block of pixels; and
determining whether said block of pixels contains all zero coefficients in accordance with said distortion measure.

2. The method of claim 1, wherein said input image is processed in real time.

3. The method of claim 1, wherein said encoder is an H.264 compliant encoder or an Advanced Video Coding (AVC) compliant encoder.

4. The method of claim 1, wherein said block of pixels comprises a 4×4 block of pixels.

5. The method of claim 1, wherein said block of pixels comprises a 8×8 block of pixels.

6. The method of claim 1, wherein said block of pixels is processed in accordance with at least one encoding function comprising: a motion estimation function, an intra prediction function, or a mode selection function.

7. The method of claim 1, wherein said determining whether said block of pixels contains all zero coefficients in accordance with said distortion measure comprises comparing said distortion measure with at least one predefined threshold.

8. The method of claim 7, wherein said at least one predefined threshold comprises a plurality of thresholds that is stored on a table.

9. The method of claim 8, wherein said plurality of thresholds correlates to a plurality of quantization levels.

10. The method of claim 7, wherein said at least one predefined threshold is computed in accordance with:
$${( \frac{h - f}{4 {M}_{3}} )}^{2}$$
where h=2^{└Q/6┘+15}, where Q is a quantization parameter, where f=h/3 or f=h/6, and where M₃ is a constant.

11. A computer readable medium having stored thereon instructions that when executed by a processor cause the processor to perform a method for processing an input image, comprising:
receiving a block of pixels from said input image;
computing a distortion measure for said block of pixels; and
determining whether said block of pixels contains all zero coefficients in accordance with said distortion measure.

12. The computer readable medium of claim 11, wherein said input image is processed in real time.

13. The computer readable medium of claim 11, wherein said encoder is an H.264 compliant encoder or an Advanced Video Coding (AVC) compliant encoder.

14. The computer readable medium of claim 11, wherein said block of pixels comprises a 4×4 block of pixels or a 8×8 block of pixels.

15. The computer readable medium of claim 11, wherein said block of pixels is processed in accordance with at least one encoding function comprising: a motion estimation function, an intra prediction function, or a mode selection function.

16. The computer readable medium of claim 11, wherein said determining whether said block of pixels contains all zero coefficients in accordance with said distortion measure comprises comparing said distortion measure with at least one predefined threshold.

17. The computer readable medium of claim 16, wherein said at least one predefined threshold is computed in accordance with:
$${( \frac{h - f}{4 {M}_{3}} )}^{2}$$
where h=2^{└Q/6┘+15}, where Q is a quantization parameter, where f=h/3 or f=h/6, and where M₃ is a constant.

18. An apparatus for processing an input image, comprising:
means for receiving a block of pixels from said input image;
means for computing a distortion measure for said block of pixels; and
means for determining whether said block of pixels contains all zero coefficients in accordance with said distortion measure.

19. The apparatus of claim 18, wherein said determining means compares said distortion measure with at least one predefined threshold.

20. The apparatus of claim 19, wherein said at least one predefined threshold is computed in accordance with:
$${( \frac{h - f}{4 {M}_{3}} )}^{2}$$
where h=2^{└Q/6┘+15}, where Q is a quantization parameter, where f=h/3 or f=h/6, and where M₃ is a constant.
